(19) United States
(12) Patent Application Publication
(10) Pub. No.: US 2011/0135783 A1
(43) Pub. Date: Jun. 9, 2011

(54) FRUIT AND VEGETABLES POWDERS WITH ORGANIC SUGAR ALCOHOLS

(75) Inventor: Ellen Piernick, Long Beach, NY (US)

(73) Assignee: ELLEN'S ORGANICS, INC., Long Beach, NY (US)

(21) Appl. No.: 12/631,439

(22) Filed: Dec. 4, 2009

(51) Int. Cl. A23L 1/29; A23L 1/09; A23L 1/212

(52) U.S. Cl. 426/2; 426/85; 426/106; 426/640; 426/648

(57) ABSTRACT

Snacks comprising an organic sugar alcohol and methods for administering servings of fruits and vegetables are provided. In a general embodiment, the present disclosure provides a snack comprising an elongated container containing a composition including an organic sugar alcohol, and a powder such as, for example, a fruit powder, a vegetable powder, an energy powder or combinations thereof.

### BACKGROUND

The present disclosure relates generally to snacks. More specifically, the present disclosure relates to organic snacks comprising organic sugar alcohols.

There are numerous types of snacks. Such snacks can include, for instance, fruit and vegetable food powders. It is generally known that providing food products having unique flavors and health benefits can lead to healthy foods that provide enhanced marketability with consumers. Currently, only 15% of the total United States population meets the recommended daily intake of fruit and vegetable servings. Only 7% of children consume two fruit servings and three vegetable servings per day, with French fries accounting for nearly 25% of vegetables in diets of our children surveyed. Such low fruit and vegetable intake leads to an increase in the excretion of calcium in the urine, while consumption of fruits and vegetables produces an alkaline diet and conserves the loss of calcium.

It is also generally known that providing foods using sugar can cause damage to tooth enamel. Tooth enamel decay results from sticky glycoproteins of sugar adhering to the teeth to start the formation of plaque. At the same time, millions of bacteria known as Streptococcus mutans also adhere to the glycoproteins. To get energy, the bacteria use the fructose from sugar in the metabolism process called glycolysis. The end product of glycolysis under anaerobic conditions is lactic acid. The lactic acid creates extra acidity in the mouth, causing a decrease in pH in the mouth to the extent needed to dissolve the calcium phosphate in the tooth enamel, leading to the start of a cavity.

It is further known that providing foods using sugar can trigger hyperglycemia, or high blood sugar, which is a condition in which an excessive amount of glucose circulates in the blood plasma. Extended stages of hyperglycemia can cause many health problems, both short-term and long-term, associated with diabetes such as, for example, eye, kidney and nerve damage. According to the National Diabetes Information Clearinghouse, 20.8 million children and adults in the United States in 2005 had some form of diabetes. Additionally, the Centers for Disease Control (CDC) predict that one in three Americans born in 2000 will develop diabetes. Research from Mintel Reports shows diabetes influencing the purchase decisions of more than a third of respondents: 34% of those purchasing sugar-free products for themselves do so for a diabetes-related reason, as do 39% who purchase sugar-free items for another household member.

A need exists therefore for a healthy and nutritious snack product that is easy to consume and that prevents dangers to the body associated with sugar and/or low intake of fruits and vegetables.

### SUMMARY OF THE INVENTION

The present disclosure is directed to snacks comprising organic sugar alcohol and methods for administering a fruit or vegetable snack comprising a sugar alcohol and an organic fruit or vegetable component. In a general embodiment, the present disclosure provides a snack comprising an elongated container containing a composition. The composition comprises an organic sugar alcohol and a powder that can be, for example, a fruit powder, a vegetable powder, an energy powder or combinations thereof. In an embodiment, the elongated container is a straw.

In an embodiment, the organic sugar alcohol can be, for example, sorbitol, erythritol, xylitol, mannitol, maltitol or combinations thereof.

In an embodiment, the fruit powder can be, for example, organic fruit powder, non-organic fruit powder or a combination thereof.

In an embodiment, the vegetable powder can be, for example, organic vegetable powder, non-organic vegetable powder or a combination thereof.

In an embodiment, the energy powder can be, for example, organic energy powder, non-organic energy powder or a combination thereof.

In an embodiment, the composition further comprises a food acid such as, for example, citric acid, tartaric acid, malic acid, fumaric acid, lactic acid, vinegar or combinations thereof.

In an embodiment, the composition further comprises an anti-caking agent such as, for example, Sodium bicarbonate, Sodium ferrocyanide, Potassium ferrocyanide, Calcium ferrocyanide, Bone phosphate, Sodium silicate, Silicon dioxide, Calcium silicate, Magnesium trisilicate, Talcum powder, Sodium aluminosilicate, Potassium aluminum silicate, Calcium aluminosilicate, Bentonite, Aluminum silicate, Stearic acid, Polydimethylsiloxane or combinations thereof.

In a further embodiment, the present disclosure provides a snack comprising an elongated container containing a composition. The composition comprises a non-organic sugar alcohol and a powder that can be, for example, an organic fruit powder, an organic vegetable powder, an organic energy powder or combinations thereof. In an embodiment, the elongated container is a straw.

In yet a further embodiment, the present disclosure provides a compressed tablet comprising an organic sugar alcohol and a powder that can be, for example, a fruit powder, a vegetable powder, an energy powder or combinations thereof. Alternatively, the compressed tablet can comprise a non-organic sugar alcohol and a powder that can be, for example, an organic fruit powder, an organic vegetable powder, an organic energy powder or combinations thereof.

In another embodiment, the present disclosure provides a method for providing a serving of fruit to a human without damaging tooth enamel and without triggering hyperglycemia. The method comprises administering to a human a fruit snack comprising an organic sugar alcohol and a fruit component, where the fruit snack is contained in at least one of an elongated container and a compressed tablet. The fruit snack is present in an amount sufficient to provide a serving of fruit to the human.

In an embodiment, the fruit component is a powder.

In an embodiment, the fruit snack further comprises a food acid such as, for example, citric acid, tartaric acid, malic acid, fumaric acid, lactic acid, vinegar or combinations thereof.

In an embodiment, the fruit snack further comprises an anti-caking agent such as, for example, Sodium bicarbonate, Sodium ferrocyanide, Potassium ferrocyanide, Calcium ferrocyanide, Bone phosphate, Sodium silicate, Silicon dioxide, Calcium silicate, Magnesium trisilicate, Talcum powder, Sodium aluminosilicate, Potassium aluminum silicate, Calcium aluminosilicate, Bentonite, Aluminum silicate, Stearic acid, Polydimethylsiloxane or combinations thereof.

In an embodiment, the fruit snack is administered in an undiluted form. Alternatively, the fruit snack is administered as part of a liquid beverage.

In yet another embodiment, the present disclosure provides a method for providing a serving of vegetables to a human without damaging tooth enamel and without triggering hyperglycemia. The method comprises administering to a human a vegetable snack comprising an organic sugar alcohol and a vegetable component, where the vegetable snack is contained in at least one of an elongated container and a compressed tablet, and is present in an amount sufficient to provide a serving of vegetables to the human.

In an embodiment, the organic vegetable component is a powder.

In an embodiment, the vegetable snack further comprises an anti-caking agent such as, for example, Sodium bicarbonate, Sodium ferrocyanide, Potassium ferrocyanide, Calcium ferrocyanide, Bone phosphate, Sodium silicate, Silicon dioxide, Calcium silicate, Magnesium trisilicate, Talcum powder, Sodium aluminosilicate, Potassium aluminum silicate, Calcium aluminosilicate, Bentonite, Aluminum silicate, Stearic acid, Polydimethylsiloxane or combinations thereof.

In an embodiment, the vegetable snack is administered in an undiluted form. Alternatively, the vegetable snack is administered as part of a liquid beverage.

In a further embodiment, the present disclosure provides a method for providing a serving of fruit to a human without damaging tooth enamel and without triggering hyperglycemia. The method comprises administering to a human a fruit snack comprising a non-organic sugar alcohol and an organic fruit component, where the fruit snack is contained in at least one of an elongated container and a compressed tablet. The fruit snack is present in an amount sufficient to provide a serving of fruit to the human.

In an even further embodiment, the present disclosure provides a method for providing a serving of vegetable to a human without damaging tooth enamel and without triggering hyperglycemia. The method comprises administering to a human a vegetable snack comprising a non-organic sugar alcohol and an organic vegetable component, where the vegetable snack is contained in at least one of an elongated container and a compressed tablet. The vegetable snack is present in an amount sufficient to provide a serving of vegetable to the human.

An advantage of the present disclosure is to provide an improved fruit, vegetable or energy snack providing health benefits.

Another advantage of the present disclosure is to provide an improved snack that is organic.

Yet another advantage of the present disclosure is to provide an improved method for administering a fruit or vegetable snack to a human without damaging tooth enamel and without triggering hyperglycemia

Additional features and advantages are described herein, and will be apparent from, the following Detailed Description.

### DETAILED DESCRIPTION

The present disclosure relates generally to snacks. More specifically, the present disclosure relates to snacks comprising sugar alcohols and a fruit, vegetable, and/or energy powder. Sugar alcohols such as erythritol, for example, do not cause tooth decay. Therefore, the consumption of sugar alcohols as a replacement for sugar can prevent damage to tooth enamel. Depending on the embodiment, the sugar alcohol can be organic or non-organic. For example, when used in combination with a non-organic fruit, vegetable, and/or energy powder, the sugar alcohol can be organic. Further, as a replacement for sugar, consumption of sugar alcohols avoids triggers to hyperglycemia, which can lead to many long-term health problems associated with diabetes such as, for example, eye, kidney and nerve damage. Accordingly, the present disclosure provides a snack in an elongated container, the snack comprising organic sugar alcohols and a fruit or vegetable powder that provides a daily serving of fruit or vegetable to a human without damaging tooth enamel and without triggering hyperglycemia.

In an embodiment, the present disclosure provides a snack comprising an elongated container containing a composition comprising an organic sugar alcohol and a powder such as, for example, a fruit powder, a vegetable powder, an energy powder or combinations thereof. The elongated container retains the composition and can be any type of elongated receptacle as is commonly known in the art such as, for example, a straw. The elongated container can be made of any type of material as is commonly known in the art such as, for example, paper or plastic. When retaining the composition within an elongated container such as a straw, the container may be oriented in any number of ways to retain the composition within the straw without allowing the composition to fall out of the straw. These ways include, for example, enclosing one end of the straw, enclosing both ends of the straw, covering the straw with a removable wrapping, and so on. The elongated container can have dimensions as necessary to provide a requisite amount of composition to a human. For example, for a 3.5 gram serving of the composition, a standard-sized drinking straw can provide sufficient space to retain the serving.

Alternatively, the composition can be in the form of a compressed tablet, such that the product can be chewed for easy consumption. Moreover, the composition can be in the form of a capsule that can be consumed directly or dispersed in a liquid to form a beverage. The capsule can be formed from any known capsule-forming ingredient including, for example, cellulose. Even further, the composition can be in the form of liquid droplets can also be consumed directly or deposited into a liquid to form a beverage.

Moreover, the elongated container can be sized to accommodate a composition amount that provides at least one serving of fruit or vegetables to a human. Further, the elongated container can be sized as needed to accommodate a composition amount that provides more than one serving of fruit or vegetables.

As used herein, the term “organic” means to produce without using most conventional pesticides, fertilizers made with synthetic ingredients or sewage sludge, bioengineering or ionizing radiation. The organic sugar alcohol can include, for example, organic sorbitol, organic erythritol, organic xylitol, organic mannitol, organic maltitol or combinations thereof.

Usage level of the sugar alcohol can vary greatly and will depend on such factors as potency of the sweetener, rate of release, desired sweetness of the food powder, level and type of flavor used in the food powder, other sugar alcohols in the food powder, the level of any other sugar alcohols in the food powder, and cost considerations.

Alternatively, an organic sugar substitute can be used instead of, or in combination with, the organic sugar alcohol. The organic sugar substitute may be, for example, stevia, brazzein, curculin, glycyrrhizin, glycerol, hydrogenated starch hydrolysate (HSH), inulin, isomalt, lactitol, luo han guo, mabinlin, miraculin, monatin, monellin, pentadin, tagatose, thaumatin or combinations thereof.

In an embodiment, the fruit powder can be organic, non-organic or a combination thereof. Similarly, the vegetable powder and energy powder can be organic, non-organic or a combination thereof. Non-limiting examples of fruit powder flavors include banana, citrus, lemon, orange, grape, lime, grapefruit, apple, pear, peach, strawberry, raspberry, cherry, plum, pineapple, apricot, any blend of flavors, combinations thereof, and so forth. Non-limiting examples of vegetable powder flavors include spinach, tomato, corn, peas, peppers, carrots, beets, broccoli, combinations thereof, and so forth. Non-limiting examples of energy powders include powders derived from goji berry, ginseng, green tea, cocoa, maca, nut, oat, combinations thereof, and so forth.

In an embodiment, the composition can further include a food acid. The food acid can include, for example, citric acid, tartaric acid, malic acid, fumaric acid, lactic acid, vinegar or combinations thereof. The food acid serves multiple purposes including, for example, regulating pH levels to foods, adding acidic flavor notes to foods, adding “sharper” flavor notes to foods, providing antioxidants to foods, and preserving foods to extend shelf-life.

In an embodiment, the composition can also include an anti-caking agent. The anti-caking agent can include, for example, Sodium bicarbonate, Sodium ferrocyanide, Potassium ferrocyanide, Calcium ferrocyanide, Bone phosphate, Sodium silicate, Silicon dioxide (silica), Calcium silicate, Magnesium trisilicate, Talcum powder (talc), Sodium aluminosilicate, Potassium aluminum silicate (microcline), Calcium aluminosilicate, Bentonite, Aluminum silicate, Stearic acid, Polydimethylsiloxane (dimethicone) or combinations thereof. Anti-caking agents, or flow agents, can be used, for among other reasons, to keep a food product from forming lumps, thus making it better for packaging, transport, and for human consumption. Anti-caking agents prevent the formation of lumps in food products by either adsorbing excess moisture in a food composition or coating food particles to make them water repellant.

It should be appreciated that the snack can provide one or more additional ingredients such as additional flavors, sensates, colors and sugar-free sweeteners (e.g. high intensity sweeteners). The ingredients can be added in a free form in any suitable amount. The ingredients can also be added in the form of encapsulation, compaction, granulation and agglomeration so as not to introduce moisture into the food powder to maintain the powdered state of the food powder.

The flavor used in the snack, in addition to the fruit, vegetable or energy powder already provided, may include any organic or natural flavor as is commonly known in the art. The organic and natural flavor may be combined in any suitable amount or in any sensory acceptable fashion. The flavor can include organic or natural agents derived from fruits and vegetables. However, the flavor can also include organic or natural agents derived from plants, leaves, flowers, and so forth. Non-limiting examples of such flavors include spearmint, cinnamon, wintergreen, peppermint, clove, bay, anise, eucalyptus, thyme, cedar leaf, nutmeg, sage, vanilla, cocoa, or combinations thereof.

It should also be appreciated that the snack can provide one or more additional functional ingredients such as fiber sources, protein sources, anti-depressants, vitamins and minerals, as well as ingredients that assist the memory, the joints, the heart, the body's pH levels, weight loss, sexual activity, sleep disorders and healthy pregnancy.

Non-limiting examples of fiber sources may include wheat bran, oat bran, fruits, vegetables, oats, rye, chia, barley, legumes, psyllium, whole grain, nuts, seeds, flax, ligans, quinoa or combinations thereof. Non-limiting examples of protein sources may include hemp, whey, soy, egg albumin, casein, peas or combinations thereof. Non-limiting examples of anti-depressants may include 5-Hydroxytryptophan (5-HTP), L-tyrosine, S-adenosyl methionine (SAMe), taurine, B-vitamins, kava, St. John's wort or combinations thereof.

Non-limiting examples of vitamins may include Vitamins A, B-complex (such as B-1, B-2, B-6 and B-12), C, D, E and K, niacin and acid vitamins such as pantothenic acid and folic acid, biotin or combinations thereof. Non-limiting examples of minerals may include calcium, iron, zinc, magnesium, iodine, copper, phosphorus, manganese, potassium, chromium, molybdenum, selenium, nickel, tin, silicon, vanadium, boron or combinations thereof.

Non-limiting examples of ingredients that assist the memory may include lecithin, boron, acetycholine, superoxide dismutases (SOD), zinc, L-carnitine, L-tyrosine, melatonin or combinations thereof. Non-limiting examples of ingredients that assist the joints may include glucosamine, chondroiten, Methylsulfonylmethane (MSM), bromelain, silica, sea cucumber, SAMe, Frankincense resin, anti-oxidants, rhizome, selenium, folate, cobalamin, vitamin D or combinations thereof. Non-limiting examples of ingredients that assist the heart may include chitosan, red yeast rice, Coenzyme Q₁₀ (also known as ubiquinone, ubidecarenone, coenzyme Q, and CoQ₁₀), phytosterols, L-carnitine or combinations thereof. Non-limiting examples of ingredients that assist the body's pH levels may include lycium, sodium hydroxide, or combinations thereof.

Non-limiting examples of ingredients that assist weight loss may include green tea, chitosan, Garcinia cambogia (Gambooge), chromium, L-carnitine or combinations thereof. Non-limiting examples of ingredients that assist sexual activity may include Epimedium (also known as Rowdy Lamb Herb, Barrenwort, Bishop's Hat, Fairy Wings, Horny Goat Weed and Yin Yang Huo), Sarsaparilla, Tribulus terrestris, ambergris, Eruca sativa, ginseng, Ginkgo biloba, dark chocolate or combinations thereof. Non-limiting examples of ingredients that assist sleep disorders may include calcium, melatonin, inositol, magnesium or combinations thereof. Non-limiting examples of ingredients that assist healthy pregnancy may include L-methionine, pre natal vitamins, quercetin, probiotics or combinations thereof.

In another embodiment, the present disclosure provides a method for providing a daily serving of fruit to a human without damaging tooth enamel and without triggering hyperglycemia. The method comprises administering to a human a fruit snack comprising an organic sugar alcohol and a fruit component. The fruit snack, alternatively, can comprise a non-organic sugar alcohol and an organic fruit component. The fruit snack can be contained in an elongated container, or can be in the form of a compressed tablet, and can be present in an amount sufficient to provide a serving of fruit to the human. The fruit snack can prevent hyperglycemia and damage to the tooth enamel by using sugar alcohols as a replacement for sugar, which can cause both tooth enamel decay and hyperglycemia.

In an embodiment, the fruit snack can be administered in an undiluted form. As a result, the fruit snack does not need to be diluted and can therefore be consumed quickly and easily. In an alternative embodiment, the fruit snack can be administered as part of a liquid beverage. To produce the liquid beverage, the fruit snack is first diluted in a diluent such as, for example, water prior to consumption.

In a further embodiment, the present disclosure provides a method for providing a daily serving of vegetables to a human without damaging tooth enamel and without triggering hyperglycemia. The method comprises administering to a human a vegetable snack comprising an organic sugar alcohol and a vegetable component. The fruit snack, alternatively, can comprise a non-organic sugar alcohol and an organic vegetable component. The vegetable snack can be contained in an elongated container, or can be in the form of a compressed tablet, and can be present in an amount sufficient to provide a serving of fruit to the human.

In an embodiment, the vegetable snack can be administered in an undiluted form. As a result, the vegetable snack does not need to be diluted and can therefore be consumed quickly and easily. In an alternative embodiment, the vegetable snack can be administered as part of a liquid beverage. To produce the liquid beverage, the vegetable snack is first diluted in a diluent such as, for example, water prior to consumption.

### EXAMPLES

By way of example and not limitation, the following examples are illustrative of various embodiments of the present disclosure.

### Example 1

### Organic Piña Colada Flavored Powder

| Ingredient | Percentage |
|---|---|
| Erythritol | 81.2% |
| Pineapple Powder | 12.0% |
| Pineapple Flavor | 3.0% |
| Citric Acid | 1.5% |
| Orange Flavor | 2.0% |
| Silica | 0.3% |

For a serving size of 3.5 grams, Example 1 has 10 calories and 3 grams of carbohydrates, 2 grams of which are erythritol. Example 1 has zero milligrams of saturated fat and zero grams of total fat, dietary fiber, sugars and protein. Moreover, for the 3.5 gram serving size, the flavored powder provides at least one serving of fruit to a human.

### Example 2

### Organic Mixed Berry Flavored Powder

| Ingredient | Percentage |
|---|---|
| Erythritol | 78.2% |
| Fruit Blend | 15.0% |
| Mixed Berry Flavor | 3.0% |
| Citric Acid | 1.5% |
| Raspberry Flavor | 2.0% |
| Silica | 0.3% |

For a serving size of 3.5 grams, Example 2 also has 10 calories and 3 grams of carbohydrates, 2 grams of which are erythritol. Like Example 1, Example 2 has zero milligrams of saturated fat and zero grams of total fat, dietary fiber, sugars and protein. Moreover, for the 3.5 gram serving size, the flavored powder provides at least one serving of fruit to a human.

### Example 3

### Organic Strawberry Flavored Powder

| Ingredient | Percentage |
|---|---|
| Erythritol | 80.4% |
| Strawberry Flavor | 10.0% |
| Pineapple Flavor | 3.0% |
| Strawberry Flavor | 4.5% |
| Citric Acid | 1.5% |
| Silica | 0.6% |

Like the previous Examples 1 and 2, for a serving size of 3.5 grams, Example 3 has 10 calories and 3 grams of carbohydrates, 2 grams of which are erythritol. Example 3 also has zero milligrams of saturated fat and zero grams of total fat, dietary fiber, sugars and protein. Moreover, for the 3.5 gram serving size, the flavored powder provides at least one serving of fruit to a human.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A snack comprising:
an elongated container containing a composition comprising:
an organic sugar alcohol, and
a powder selected from the group consisting of a fruit powder, a vegetable powder, an energy powder and combinations thereof.

2. The snack of claim 1, wherein the elongated container is a straw.

3. The snack of claim 1, wherein the organic sugar alcohol is selected from the group consisting of sorbitol, erythritol, xylitol, mannitol, maltitol and combinations thereof.

4. The snack of claim 1, wherein the fruit powder is selected from the group consisting of organic fruit powder, non-organic fruit powder and a combination thereof.

5. The snack of claim 1, wherein the vegetable powder is selected from the group consisting of organic vegetable powder, non-organic vegetable powder and a combination thereof.

6. The snack of claim 1, wherein the energy powder is selected from the group consisting of organic energy powder, non-organic energy powder and a combination thereof.

7. The snack of claim 1, wherein the composition further comprises a food acid selected from the group consisting of citric acid, tartaric acid, malic acid, fumaric acid, lactic acid, vinegar and combinations thereof.

8. The snack of claim 1, wherein the composition further comprises an anti-caking agent selected from the group consisting of Sodium bicarbonate, Sodium ferrocyanide, Potassium ferrocyanide, Calcium ferrocyanide, Bone phosphate, Sodium silicate, Silicon dioxide, Calcium silicate, Magnesium trisilicate, Talcum powder, Sodium aluminosilicate, Potassium aluminum silicate, Calcium aluminosilicate, Bentonite, Aluminum silicate, Stearic acid, Polydimethylsiloxane and combinations thereof.

9. A snack comprising:
an elongated container containing a composition comprising:
a non-organic sugar alcohol, and
a powder selected from the group consisting of an organic fruit powder, an organic vegetable powder, an organic energy powder and combinations thereof.

10. The snack of claim 9, wherein the elongated container is a straw.

11. The snack of claim 9, wherein the sugar alcohol is selected from the group consisting of sorbitol, erythritol, xylitol, mannitol, maltitol and combinations thereof.

12. The snack of claim 9, wherein the composition further comprises a food acid selected from the group consisting of citric acid, tartaric acid, malic acid, fumaric acid, lactic acid, vinegar and combinations thereof.

13. The snack of claim 9, wherein the composition further comprises an anti-caking agent selected from the group consisting of Sodium bicarbonate, Sodium ferrocyanide, Potassium ferrocyanide, Calcium ferrocyanide, Bone phosphate, Sodium silicate, Silicon dioxide, Calcium silicate, Magnesium trisilicate, Talcum powder, Sodium aluminosilicate, Potassium aluminum silicate, Calcium aluminosilicate, Bentonite, Aluminum silicate, Stearic acid, Polydimethylsiloxane and combinations thereof.

14. A compressed tablet comprising:
an organic sugar alcohol, and
a powder selected from the group consisting of a fruit powder, a vegetable powder, an energy powder and combinations thereof.

15. The compressed tablet of claim 14, wherein the organic sugar alcohol is selected from the group consisting of sorbitol, erythritol, xylitol, mannitol, maltitol and combinations thereof.

16. The compressed tablet of claim 14, wherein the fruit powder is selected from the group consisting of organic fruit powder, non-organic fruit powder and a combination thereof.

17. The compressed tablet of claim 14, wherein the vegetable powder is selected from the group consisting of organic vegetable powder, non-organic vegetable powder and a combination thereof.

18. The compressed tablet of claim 14, wherein the energy powder is selected from the group consisting of organic energy powder, non-organic energy powder and a combination thereof.

19. The compressed tablet of claim 14, further comprising a food acid selected from the group consisting of citric acid, tartaric acid, malic acid, fumaric acid, lactic acid, vinegar and combinations thereof.

20. The compressed tablet of claim 14, further comprising an anti-caking agent selected from the group consisting of Sodium bicarbonate, Sodium ferrocyanide, Potassium ferrocyanide, Calcium ferrocyanide, Bone phosphate, Sodium silicate, Silicon dioxide, Calcium silicate, Magnesium trisilicate, Talcum powder, Sodium aluminosilicate, Potassium aluminum silicate, Calcium aluminosilicate, Bentonite, Aluminum silicate, Stearic acid, Polydimethylsiloxane and combinations thereof.

21. A compressed tablet comprising:
a non-organic sugar alcohol, and
a powder selected from the group consisting of an organic fruit powder, an organic vegetable powder, an organic energy powder and combinations thereof.

22. The compressed tablet of claim 21, wherein the sugar alcohol is selected from the group consisting of sorbitol, erythritol, xylitol, mannitol, maltitol and combinations thereof.

23. The compressed tablet of claim 21, further comprising a food acid selected from the group consisting of citric acid, tartaric acid, malic acid, fumaric acid, lactic acid, vinegar and combinations thereof.

24. The compressed tablet of claim 21, further comprising an anti-caking agent selected from the group consisting of Sodium bicarbonate, Sodium ferrocyanide, Potassium ferrocyanide, Calcium ferrocyanide, Bone phosphate, Sodium silicate, Silicon dioxide, Calcium silicate, Magnesium trisilicate, Talcum powder, Sodium aluminosilicate, Potassium aluminum silicate, Calcium aluminosilicate, Bentonite, Aluminum silicate, Stearic acid, Polydimethylsiloxane and combinations thereof.

25. A method for providing a serving of fruit to a human without damaging tooth enamel and without triggering hyperglycemia, the method comprising:
administering to a human a fruit snack comprising an organic sugar alcohol and a fruit component, wherein the fruit snack is contained in at least one of an elongated container and a compressed tablet, and is present in an amount sufficient to provide at least one serving of fruit to the human.

26. The method of claim 25, wherein the fruit component is selected from the group consisting of an organic fruit component, a non-organic fruit component, and a combination thereof.

27. The method of claim 25, wherein the fruit component is a powder.

28. The method of claim 25, wherein the fruit snack further comprises a food acid selected from the group consisting of citric acid, tartaric acid, malic acid, fumaric acid, lactic acid, vinegar and combinations thereof.

29. The method of claim 25, wherein the fruit snack further comprises an anti-caking agent selected from the group consisting of Sodium bicarbonate, Sodium ferrocyanide, Potassium ferrocyanide, Calcium ferrocyanide, Bone phosphate, Sodium silicate, Silicon dioxide, Calcium silicate, Magnesium trisilicate, Talcum powder, Sodium aluminosilicate, Potassium aluminum silicate, Calcium aluminosilicate, Bentonite, Aluminum silicate, Stearic acid, Polydimethylsiloxane and combinations thereof.

30. The method of claim 25, wherein the fruit snack is administered in an undiluted form.

31. The method of claim 25, wherein the fruit snack is administered as part of a liquid beverage.

32. A method for providing a serving of vegetables to a human without damaging tooth enamel and without triggering hyperglycemia, the method comprising:
administering to a human a vegetable snack comprising an organic sugar alcohol and a vegetable component, wherein the vegetable snack is contained in at least one of an elongated container and a compressed tablet, and is present in an amount sufficient to provide at least one serving of vegetables to the human.

33. The method of claim 32, wherein the vegetable component is selected from the group consisting of an organic vegetable component, a non-organic vegetable component, and a combination thereof.

34. The method of claim 32, wherein the vegetable component is a powder.

35. The method of claim 32, wherein the vegetable snack further comprises an anti-caking agent selected from the group consisting of Sodium bicarbonate, Sodium ferrocyanide, Potassium ferrocyanide, Calcium ferrocyanide, Bone phosphate, Sodium silicate, Silicon dioxide, Calcium silicate, Magnesium trisilicate, Talcum powder, Sodium aluminosilicate, Potassium aluminum silicate, Calcium aluminosilicate, Bentonite, Aluminum silicate, Stearic acid, Polydimethylsiloxane and combinations thereof.

36. The method of claim 32, wherein the vegetable snack is administered in an undiluted form.

37. The method of claim 32, wherein the vegetable snack is administered as part of a liquid beverage.

38. A method for providing a serving of fruit to a human without damaging tooth enamel and without triggering hyperglycemia, the method comprising:
administering to a human a fruit snack comprising a non-organic sugar alcohol and an organic fruit component, wherein the fruit snack is contained in at least one of an elongated container and a compressed tablet, and is present in an amount sufficient to provide at least one serving of fruit to the human.

39. A method for providing a serving of vegetables to a human without damaging tooth enamel and without triggering hyperglycemia, the method comprising:
administering to a human a vegetable snack comprising a non-organic sugar alcohol and an organic vegetable component, wherein the vegetable snack is contained in at least one of an elongated container and a compressed tablet, and is present in an amount sufficient to provide at least one serving of vegetables to the human.
